(19) United States
(12) Patent Application Publication
(10) Pub. No.: US 2018/0174555 A1
(43) Pub. Date: Jun. 21, 2018

(54) DISPLAY APPARATUS AND DISPLAY METHOD THEREOF

(71) Applicant: SAMSUNG ELECTRONICS CO., LTD., Suwon-si (KR)

(72) Inventors: Dae-bong LEE, Yongin-si (KR); Ha-na KIM, Suwon-si (KR); Soo-hong KIM, Seoul (KR)

(73) Assignee: SAMSUNG ELECTRONICS CO., LTD., Suwon-si (KR)

(21) Appl. No.: 15/831,585

(22) Filed: Dec. 5, 2017

(30) Foreign Application Priority Data
Dec. 20, 2016 (KR) 10-2016-0174445
Aug. 18, 2017 (KR) 10-2017-0104707

(51) Int. Cl. G09G 5/377; G09G 5/14; G09G 5/10

(52) U.S. Cl. CPC G09G 5/377; G09G 5/14; G09G 2340/12; G09G 2360/144; G09G 2340/10; G09G 5/10

(57) ABSTRACT

A display apparatus is provided. The display apparatus includes a display configured to display a main image and a processor configured to control the display to display the main image at a preset image ratio that is different from an aspect ratio of the display, and in response to an empty area of the display where the main image is not displayed being present in the display, control the display to display a secondary image in the empty area. The secondary image may correspond to an image of a background area positioned behind the display apparatus or an image of a surrounding area that surrounds the display apparatus.

### CROSS-REFERENCE TO RELATED APPLICATIONS

This application claims priority from Korean Patent Application Nos. 10-2016-0174445 and 10-2017-0104707, respectively filed on Dec. 20, 2016 and Aug. 18, 2017, in the Korean Intellectual Property Office, the disclosures of which are incorporated herein by reference in their entireties.

### BACKGROUND

### Field

Apparatuses and methods consistent with exemplary embodiments relate to a display apparatus and a display method thereof, and more particularly, to a display apparatus for displaying an image in an area of a display, and a display method thereof.

### Description of the Related Art

A display apparatus may process a digital or analog image signal received from an external source, and an image signal stored as a compressed file in an internal storage device, and may generate an image based on the processed image signal.

If an image having a different ratio from a screen ratio of a display is input, an existing display apparatus may display the input image together with black bars to fill the display screen.

When black bars appear in the display screen, some people may found these black bars distracting and may have difficulty being immersed in viewing the image.

### SUMMARY

Exemplary embodiments address at least the above problems and/or disadvantages and other disadvantages not described above. Also, the exemplary embodiments are not required to overcome the disadvantages described above, and may not overcome any of the problems described above.

One or more exemplary embodiments provide a display apparatus for enabling a user to be immersed in viewing an input image by displaying a background image appearing behind the display apparatus in an other area of a display where the input image is not displayed when displaying the input image in an area of the display of the display apparatus, and a display method thereof.

According to an aspect of an exemplary embodiment, there is provided a display apparatus including: a display configured to display a main image; and a processor configured to control the display to display the main image at a preset image ratio that is different from an aspect ratio of the display, and in response to an empty area of the display where the main image is not displayed being present in the display, control the display to display a secondary image in the empty area, wherein the secondary image may correspond to an image of a background area positioned behind the display apparatus or an image of a surrounding area that surrounds the display apparatus.

The display apparatus may further include: an image processor configured to generate a first layer corresponding to the main image, generate a second layer corresponding to the secondary image, and combine the first layer and the second layer to display the second layer in the empty area. The processor may be further configured to control the display and the image processor to display the mixed image on the display.

The image processor may be configured to mix the second layer with a black area of the first layer.

The processor may be configured to control the display to display a virtual bezel on a boundary between the main image and the secondary image.

The display apparatus may further include: a sensor configured to sense an external light environment, wherein the processor may be further configured to determine a lighting direction based on the sensed external light environment and control the display to display a shadow object of the virtual bezel in a position corresponding to the determined lighting direction.

In response to a portion of a pattern of the secondary image being displayed at a predetermined position in the empty area, the processor may control the display to change the position of the portion of the pattern within the empty area.

The processor may be configured to control the display to display a third image in a preset area of the secondary image.

The processor may be further configured to extract an object included in the main image from the main image and control the display to display the extracted object in an area of the display.

The main image may include a foreground image and a background image, and the processor may be further configured to extract the foreground image as the object from the main image and control the display to display the extracted object on the display.

In response to a plurality of objects included in the main image being arranged uniformly, the processor may be further configured to extract another plurality of objects except for the plurality of objects and control the display to display the extracted another plurality of objects on the display.

The processor may be further configured to determine a vanishing point from the background image of the main image, extract an area based on the vanishing point, and controls the display to display the extracted area on the display.

In response to the main image including a first object and a second object symmetrical to the first object, the processor may be further configured to extract the first and second objects from the main image and control the display to display the extracted first and second objects on the display.

The processor may be further configured to determine a position of the object included in the main image and control the display to display the main image in an area of the display corresponding to the determined position.

The processor may be further configured to determine an eye direction of the object included in the main image and control the display to display the main image in an area existing in an opposite direction to the determined eye direction on the display.

According to an aspect of another exemplary embodiment, there is provided a display method including: displaying, on a display, a main image at a preset image ratio; determining whether an empty area where the main image is not displayed exists on the display; and in response to determining that the empty area exists, displaying a secondary image in the empty, wherein the secondary image may correspond to an image of a background area positioned behind the display or an image of a surrounding area that surrounds the display.

The displaying the secondary image may include: generating a first layer corresponding to the main image; generating a second layer corresponding to the secondary image; and combining the first layer and the second layer to display the second layer in the empty area.

The combining may include combining the second layer with a black area of the first layer.

The displaying the secondary image may include displaying a virtual bezel on a boundary between the main image and the secondary image.

The display method may further include: sensing an external light environment of the display; and determining a lighting direction based on the sensed external light environment, wherein the displaying the secondary image may include displaying a shadow object of the virtual bezel together in a position corresponding to the determined lighting direction.

The displaying the secondary image may include, in response to a portion of a pattern of the secondary image being displayed at a predetermined position in the empty area, changing the position of the portion of the pattern.

According to an aspect of another exemplary embodiment, there is provided a display apparatus including: a display configured to display a primary image; a processor configured to determine whether a size of the primary image is less than a size of a screen of the display, generate a secondary image that repeats a background pattern seamlessly in response to the size of the primary image being less than the size of the screen, the background pattern representing a pattern that exists in an area behind the display or in an area surrounding the display, and control the display to lay the primary image over the secondary image.

The display apparatus may further include an optical sensor configured to detect an intensity of an ambient light, wherein the processor may be further configured to adjust a brightness level of the secondary image based on the intensity of the ambient light.

The background pattern of the secondary image may include repeating objects, and the processor may be further configured to arrange at least one of the repeating objects in response to the at least one repeating object being displayed immediately adjacent to the primary image.

According to various exemplary embodiments, a display apparatus may provide an immersion for a user who views an input image, by displaying a background image appearing behind the display apparatus in an other area of a display where the input image is not displayed when displaying the input image in an area of the display.

Also, the display apparatus may provide the user with a portion which is a point of the input image by extracting and displaying a portion of an object included in the input image when displaying the input image in the area of the display. In addition, the display apparatus may enable the user to aesthetically enjoy the input image by displaying the input image in a natural and stable position.

### BRIEF DESCRIPTION OF THE DRAWINGS

The above and/or other aspects will be more apparent by describing certain exemplary embodiments, with reference to the accompanying drawings, in which:

FIG. 1 illustrates a visual effect that is applied to a background image of a display apparatus according to an exemplary embodiment;

FIG. 2 is a block diagram of a simplified configuration of a display apparatus according to an exemplary embodiment;

FIG. 3 is a block diagram of a detailed configuration of a display apparatus according to an exemplary embodiment;

FIG. 4 is a block diagram of a detailed configuration of an image processor of FIG. 3, according to an exemplary embodiment;

FIG. 5 illustrates an example of a display screen in a first operation mode;

FIGS. 6 and 7 illustrate various examples of a display screen according to changes in an aspect ratio;

FIG. 8 illustrates an example of a display screen in a second operation mode;

FIG. 9 illustrates an example of a display screen according to a position change of a main screen;

FIG. 10 illustrates an example of a display screen displaying a third image;

FIG. 11 illustrates an example of a display screen displaying a virtual bezel;

FIG. 12 illustrates an example of checking a preset pattern and controlling a background screen according to the checked preset pattern;

FIG. 13 illustrates an example of displaying a background screen on an empty screen if a display apparatus pivots;

FIGS. 14 through 17 illustrate an example of extracting an object included in a main image and displaying an image including the extracted object in an area of a display by using a display apparatus;

FIGS. 18A, 18B, 19A, and 19B illustrate a method of displaying a main image in an area of a display based on an attribute of an object included in the main image by using a display apparatus;

FIG. 20 is a flowchart of a display method according to an exemplary embodiment; and

FIG. 21 is a flowchart of a display method according to another exemplary embodiment.

### DETAILED DESCRIPTION

Exemplary embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the exemplary embodiments. However, it is apparent that the exemplary embodiments can be practiced without those specifically defined matters. Also, well-known functions or constructions are not described in detail since they would obscure the description with unnecessary detail.

Although the terms ‘first’, ‘second’, etc. may be used herein to describe various elements regardless of orders and/or importances, these elements may not be limited by these terms. These terms are merely used to distinguish one element from another.

The terms used herein are used to describe merely a particular exemplary embodiment and is not intended to limit the scope of the disclosure. The singular expression also includes the plural meaning as long as it does not differently mean in the context. In the present application, the terms “include” and “comprise” designate the presence of features, numbers, steps, operations, components, elements, or a combination thereof that are written in the specification, but do not exclude the presence or possibility of addition of one or more other features, numbers, steps, operations, components, elements, or a combination thereof.

In the exemplary embodiments, a “module” or a “part” performs at least one function or operation, and may be implemented with hardware, software, or a combination thereof. In addition, a plurality of “modules” or a plurality of “parts” may be integrated into at least one module, except for a “module” or a “part” which has to be implemented as particular hardware so as to be implemented as at least one processor.

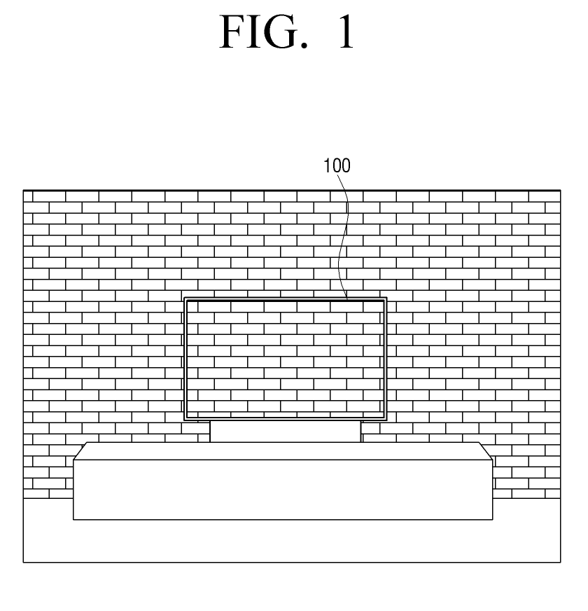

FIG. 1 illustrates a visual effect that is applied to a background image of a display apparatus, according to an exemplary embodiment. The background image may correspond to an image of an area positioned behind the display apparatus or an image of an area surrounding the display apparatus. The background image may be also referred to as a secondary image to distinguish from an image including a background and a foreground.

FIG. 1 illustrates an operation of a display apparatus 100 according to an exemplary embodiment.

The display apparatus 100 according to the exemplary embodiment may have two operation modes. In a first operation mode, the display apparatus 100 may display a normal image, for example, a pre-stored content or a broadcast received from an external source, by using an entire screen of the display apparatus 100.

In a second operation mode, the display apparatus 100 may display a background screen that is realistically blended into the actual background of the display apparats 100 and therefore the user may not easily recognize the presence of the display apparatus 100. Here, the background screen may be a screen acquired by pre-capturing the actual background behind the display apparatus 100.

If the background screen is displayed in the second operation mode, the display apparatus 100 displays an image of background, which is hidden behind the display apparatus 100, as the background screen of the display apparatus 100. Therefore, the user may feel as if the display apparatus 100 becomes a transparent window.

In the second operation mode, only the background screen may be displayed or the background screen may be displayed together with a particular object. Here, the particular object may be a clock object, but various types of objects (e.g., a picture, a photo, a fishbowl, and the like) that may be attached onto a normal wall may be displayed.

If the display apparatus 100 operates in the second operation mode, the display apparatus 100 may set a brightness of the background screen that allows a difference between the brightness of the background screen and a brightness of a real background environment to be less than a predetermined value. The predetermined value is set to be a brightness difference that may not be perceived by humans. Therefore, the user may not recognize the difference between the display apparatus 100 and the real background environment.

The background screen displayed on the display apparatus 100 may be adaptively changed according to a change in a surrounding environment of the display apparatus 100.

As a result, the display apparatus 100 according to the present exemplary embodiment may sense a ambient light environment and may adaptively control brightness of an image displayed on the display apparatus 100 according to the sensed ambient light environment.

If the display apparatus 100 displays the background screen together with an object, the display apparatus 100 may provide a three-dimensional effect that enables the displayed object and the background screen to have different depths.

The display apparatus 100 displays an image by using an entire area of a screen or may display the image by using only portion of the screen instead of using the entire area of the screen, according to a screen ratio selected by the user. For example, when displaying a content having a ratio of 4:3 on a display having a ratio of 16:9, the content may be displayed through various types of screen processing. One of the various types of screen processing is to display a content by converting a ratio of a content screen of 4:3 to 16:9.

Another type of screen processing is a method of displaying a content at a ratio of 4:3 as it is and displaying an empty area on left and/or right sides of a content image together. In this case, a black empty area is disposed on left and right sides of an image. If such an empty area is displayed, the user simultaneously sees three different kinds of environments including a real background, a black color, and an image, and thus a concentration of the user on the image is lowered. Here, the empty area may be referred to as a blank area, a black area, a black bar, an image non-display area, or the like.

Therefore, if there is an empty image where a main image is not displayed when the display apparatus 100 according to the present exemplary embodiment operates in the first operation mode, a background image may be displayed in the empty image. As a result, the user does not need to see a different empty image and thus may concentrate on the main image. A function of displaying a background image in such an empty image may be an additional third operation mode distinguished from the first operation mode and may also automatically operate in the first operation mode.

In the illustrated exemplary embodiment, a background area is displayed in an existing empty area, and thus the empty area is not displayed in a final result. However, hereinafter, for convenience of description, an area where a main image is not displayed will be referred to as an empty area. The main image may be also referred to as a primary image, and an image displayed in the empty area may be referred to as a secondary image.

Hereinafter, the above-described operation will be described in detail by using detailed elements of a display apparatus.

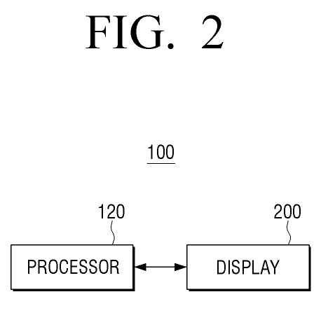

FIG. 2 is a block diagram of a simplified configuration of the display apparatus 100, according to an exemplary embodiment.

Referring to FIG. 2, the display apparatus 100 includes a processor 120 and a display 200.

The display 200 displays an image. The display 200 may be realized as various types of displays such as a Liquid Crystal Display (LCD), a Plasma Display Panel (PDP), and the like. The display 200 may further include a driving circuit, which may be realized as a type such as an Amorphous Silicon (a-si) Thin Film Transistor (TFT), a Low Temperature Poly Silicon (LTPS) TFT, an organic TFT (OTFT), or the like, a backlight unit, and the like. The display 200 may be realized as a touch screen by being combined with a touch sensor unit.

The display 200 includes backlight. Here, the backlight operates as a point light source including a plurality of light sources and supports local dimming.

Here, a light source constituting the backlight may be constituted as a Cold Cathode Fluorescent Lamp (CCFL) or a Light Emitting Diode (LED). Hereinafter, the backlight will be illustrated and described as including an LED and an LED driving circuit but may be realized as another type of element besides the LED. Also, a plurality of light sources constituting the backlight may be disposed in various forms and may use various types of local dimming technologies. For example, the backlight may be direct type backlight where a plurality of light sources are disposed in a matrix form to be uniformly disposed in an entire area of an LCD. In this case, the backlight may operate as Full-Array local dimming or Direct local dimming. Here, the Full-Array local dimming is a dimming method of enabling light sources to be uniformly disposed on a back of an LCD and controlling luminance of each of the light sources. Also, the Direct local dimming is a dimming method that is similar to the Full-Array local dimming, disposes the smaller number of light sources than the Full-Array local dimming, and controls luminance of each of the light sources.

In addition, the backlight may be Edge type backlight where a plurality of light sources are disposed merely on an edge of an LCD. In this case, the backlight may operate as Edge-lit local dimming. Here, the Edge-light local dimming may include a plurality of light sources that are disposed on an edge of a panel, on left and/or right sides of the panel, on upper and lower sides of the panel, or on left and/or right sides and upper and/or lower sides of the panel.

The processor 120 controls an overall operation of the display apparatus 100. In detail, the processor 120 determines an operation mode of the display apparatus 100. In more detail, if a TV display command or a content display command is input from the user, the processor 120 may determine that the operation mode of the display apparatus 100 is the first operation mode of displaying the normal image.

If a power command is input or a change command of the operation mode is input in the first operation mode, the processor 120 may determine that the operation mode of the display apparatus 100 is the second operation mode of displaying the background screen. Therefore, the first operation mode and the second operation mode may be changed according to a normal power operation of the user according to an exemplary embodiment.

Also, if the user presses a power button for a preset time when the display apparatus 100 operates in the first operation mode or the second operation mode, the processor 120 may change the operation mode of the display apparatus 100 into a normal power off mode.

In addition, if a power command is input in the normal power off mode, the processor 120 may determine that the display apparatus 100 operates in an operation mode set right before power off.

If the operation mode of the display apparatus 100 is determined as the first operation mode, the processor 120 may control the display 200 to display an image according to a control command input through a manipulator 175.

Here, the processor 120 may control the display 200 to display a main image at a preset image ratio. For example, the user may preset a ratio (e.g., 16:9, 4:3, or the like) of a displayed image, receive setting of a correlation between the display 200 and a content (e.g., fill the display 200, dispose the display 200 in a center, or the like), and control the display 200 to display the main image according to this preset state.

If a change command of the image ratio is input from the user in a process of displaying an image, the processor 120 may control the display 200 to display the image at a changed ratio.

The processor 120 may also check a rotation state (or a pivot state) of the display apparatus 100 and control the display 200 to display the main image according to the checked rotation state.

In addition, the processor 120 may control the display 200 to display a background image in an empty area appearing due to a ratio difference between the display 200 and the image. In detail, the processor 120 checks an empty area on the display 200 by checking whether the display 200 includes an area that is displayed with a black color (or the display 200 includes an area where a main layer is not filled). In more detail, the processor 120 may check the empty area by checking an area (i.e., a black area) where the main image is not displayed on a first layer corresponding to the main image.

As described above, an empty area is checked according to whether a black area exists. However, the empty area may be checked based on a display area of a main image or according to a content display method set by the user. In other words, the empty area may be checked according to various methods besides the above-described method.

Also, if the empty area is checked, the processor 120 may control the display 200 to display a portion of the background image corresponding to a corresponding position in the checked empty area. Here, the background image may be a photo image of a background area that is positioned behind the display apparatus 100 or an image of an area that surrounds the display apparatus 100. Also, the background image may further include an additional graphic image.

For example, the image of the background behind the display apparatus 100 or the image of an area that surrounds the display apparatus 100 may be captured by a camera included in the display apparatus 100 or another external device (e.g., a smartphone camera). The processor 120 of the display apparatus 100 may repeatedly generate the captured background or surrounding image and render the boundary lines between the repeating images seamlessly.

Here, the processor 120 may control the display 200 to enable a virtual bezel to be positioned between the main image and the background image. An effect of installing a display smaller than a real display apparatus on a wall may be provided by displaying the virtual bezel between the main image and the background image as described above.

The processor 120 may also enable the virtual bezel to be further realistically seen by sensing a light environment, checking a direction of light according to the sensed light environment, and displaying a shadow object of the virtual bezel together in a position corresponding to the checked direction of the light.

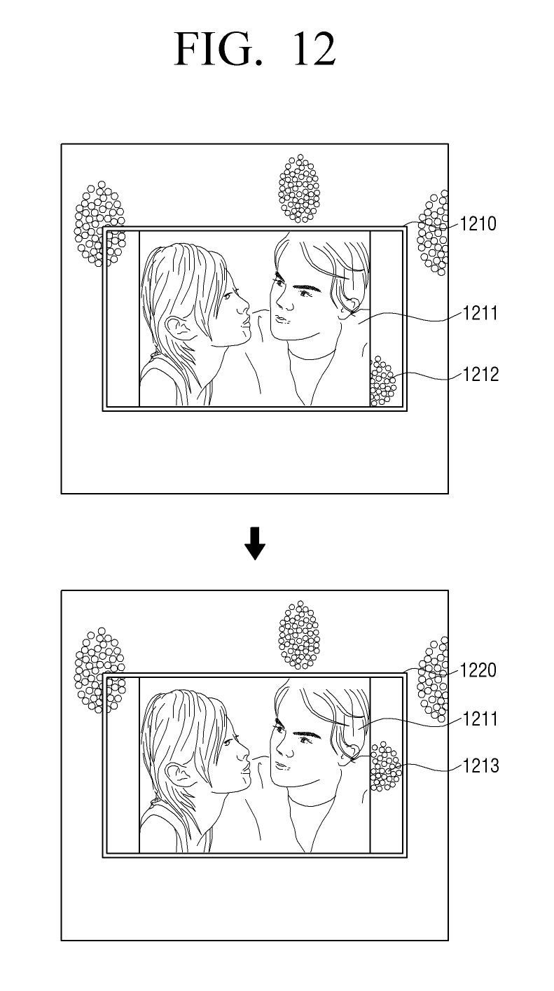

If a portion of a preset pattern of the background image is displayed by the main image, the processor 120 may control the display 200 to control and display a position of the preset pattern in the background image. This operation will be described later with reference to FIG. 12.

The processor 120 may also perform the above-described operation by using a first background image when the display apparatus 100 operates in a transverse mode and perform the above-described operation by using a second background image when the display apparatus 100 operates in a longitudinal mode. In detail, the display apparatus 100 that has been recently launched may support a pivot function of enabling the display apparatus 100 to pivot and may change a mode thereof to the transverse mode or the longitudinal mode according to the pivot function.

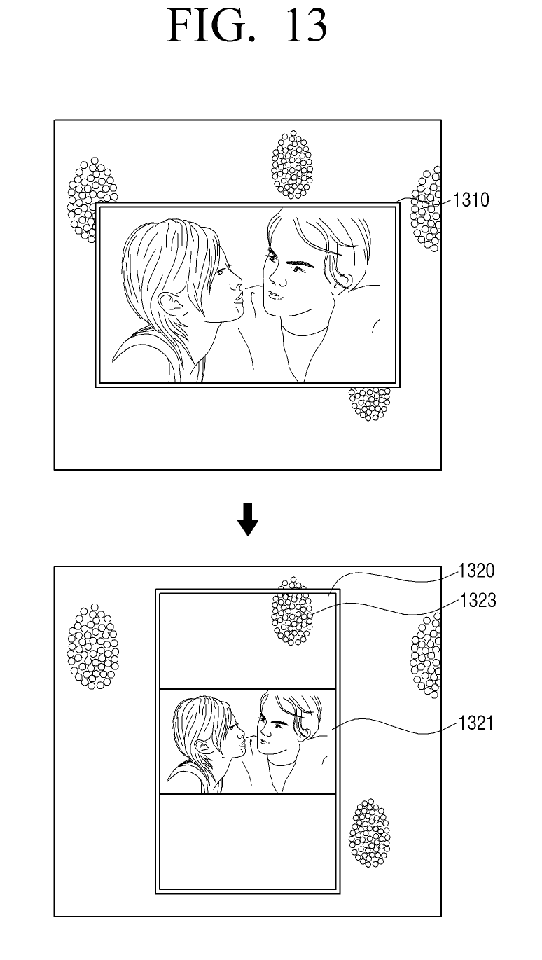

However, since a background covered with the display 100 is different respectively in the transverse mode and the longitudinal mode, the processor 120 may perform an operation by using different background images according to the pivot state. An example of this operation will be described later with reference to FIG. 13.

If the operation mode of the display apparatus 100 is determined as the second operation mode, the processor 120 may control the display 200 to display the background image.

The processor 120 may also control a sensor unit 180 to sense a light environment of a periphery of the display apparatus 100 and may determine an intensity and a direction of the light according to the sensed light environment.

The processor 120 may also perform image processing on a background image that will be displayed according to the sensed light environment (e.g., the intensity and the direction of the light). In detail, the processor 120 may perform image processing to change a color temperature of a background image based on a color temperature sensed by the sensor unit 180. The sensor unit 180 may be realized as an optical sensor.

In addition, the processor 120 may control the display 200 to display an object together when displaying the background image. In detail, the processor 120 may generate a screen including a preset object and a background image and provide the display 200 with the generated screen. Here, the preset object may be an analog clock, or a digital clock, or the like and may also be various types of graphic objects such as a photo, a picture, a fishbowl, and the like. Such a graphic object may be a static graphic object such as a photo, a picture, or the like or may be a moving object.

The processor 120 may also determine the light direction according to the sensed light environment and control the display 200 to display a shadow object of an object in a position corresponding to the determined light direction.

Moreover, the processor 120 may determine a size of the shadow object according to sensed light value and color temperature and control the display 200 to display the shadow object having the determined size. For example, a shadow may be changed according to an intensity or a color temperature of light. Therefore, the display apparatus 100 according to the present exemplary embodiment may also generate and display a graphic object based on an intensity and a color temperature of light.

In addition, in order to save power when operating in the second operation mode, the processor 120 may display the background image only when the display apparatus 100 determines that the user is present within a predetermined distance range from the display apparatus 100, for example, using an infrared sensor. If the display apparatus 100 determines that the user is not located within the predetermined distance range from the display apparatus 100 when operating in the second operation mode, the processor 120 may not display the background image. According to an exemplary embodiment, the display apparatus 100 may not have information of the predetermined distance range, and may display the background image in response to the infrared sensor detecting the user, without determination of whether the detected user is placed within the predetermined distance range.

The processor 120 may also control the display 200 to operate in the second operation mode at a lower frame rate than a frame rate at which the display 200 operates in the first operation mode. For example, if the display 200 displays an image at a frequency of 240 Hz in the first operation mode, the processor 120 may control the display 200 to operate at a frequency of 120 Hz or 60 Hz, which is less than 240 Hz, in the second operation mode.

If the sensor unit 180 does not sense the user the processor 120 may control the display 200 not to perform a display operation of an image.

In addition, the processor 120 may enable a corresponding object to be displayed or may perform a particular event based on weather information received by a communicator (e.g., communication interface) 170 that will be described later. For example, if rain is forecast according to the weather information, the processor 120 may control the display 200 to display a graphic object related to rain on a background screen or may control an audio output unit 155 to output a sound of rain.

As described above, the display apparatus 100 according to the present exemplary embodiment may give a more immersion to a main image by displaying a background screen in an empty area appearing when displaying the main image.

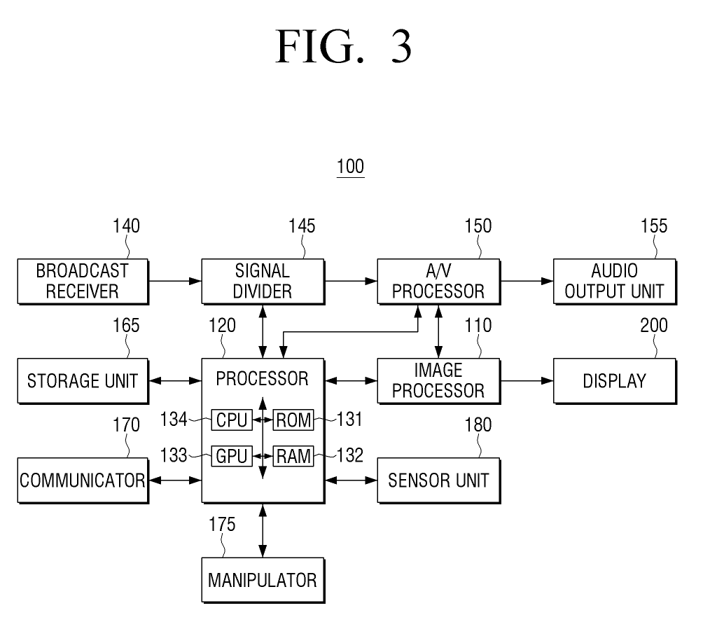

The simplified configuration of the display apparatus 100 has been described above, but the display apparatus 100 may further include elements as shown in FIG. 3. A detailed configuration of the display apparatus 100 will now be described with reference to FIG. 3.

As described above with reference to FIG. 2, the processor 120 performs an operation of checking an empty area and displaying a background screen in the empty area. However, the operation of checking the empty area and displaying the background screen in the empty area may be performed by an additional apparatus, and the processor 120 may control the corresponding additional apparatus to perform the operation as described above.

FIG. 3 is a block diagram of a detailed configuration of the display apparatus 100, according to an exemplary embodiment.

Referring to FIG. 3, the display apparatus 100 according to the present exemplary embodiment may include an image processor 110, the processor 120, the display 200, a broadcast receiver 140, a signal divider 145, an audio/video (A/V) processor 150, the audio output unit 155, an image signal generator, a storage unit 165, a communicator 170, the manipulator 175, and the sensor unit 180.

A configuration of the display 200 of FIG. 3 may the same as that of the display 200 of FIG. 2, and thus a repeated description thereof is omitted.

The image processor 110 generates a Graphic User Interface (GUI) for being provided for the user. The GUI may be an On Screen Display (OSD), and the image processor 110 may be realized as a Digital Signal Processor (DSP).

The image processor 110 may also add the generated GUI to an image output from the A/V processor 150 that will be described later. In addition, the image processor 110 may provide the display 200 with an image signal corresponding to the image to which the GUI is added. Therefore, the display 200 displays various types of information provided in the display apparatus 100 and the image transmitted from the image signal generator.

In addition, the image processor 110 may receive a background image as one layer (or a main layer), receive an image generated by the A/V processor 150 or an object image provided from the processor 120 as another layer (or a sub layer), output one of the two layers or synthesize (or mix) the two layers, and provide the display 200 with the synthesized (or mixed) layer.

In detail, the image processor 110 may generate a first layer corresponding to the main image, generate a second layer corresponding to the background image, and if an empty area is checked on the first layer, and mix the first layer and the second layer to display the second layer in the empty area of the first layer.

According to another exemplary embodiment, the image processor 110 may lay the first layer over the second layer so that the viewer may see the entire portion of the first layer together with a portion of the second layer that is not overlaid by the first layer.

Here, the image processor 110 may perform different types of image processing with respect to the input two layers (i.e., the main image and the background image) and mix the two layers on which the different types of image processing are performed.

The image processor 110 may also perform image quality post-processing with respect to a mixed (or merged) image.

In addition, the image processor 110 may extract brightness information corresponding to the image signal and generate one dimming signal (if the display apparatus 100 operates as global dimming) or a plurality of dimming signals (if the display apparatus 100 operates as local dimming) corresponding to the extracted brightness information. Here, the image signal generator may generate a dimming signal as described above in consideration of the light environment sensed by the sensor unit 180. The dimming signal may be a Pulse Width Modulation (PWM) signal.

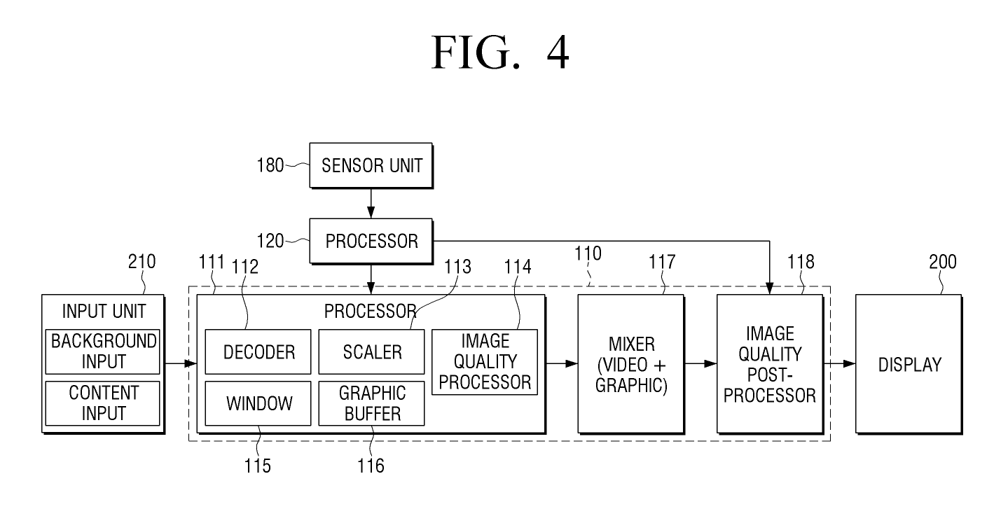

With reference to FIG. 4, the image processor 110 is described as a separate part from the processor 120, but according to an exemplary embodiment, all or part of the operations performed by the image processor 110 may be performed by the processor 120. Additionally, the processor 120 may be embodied as plural processors.

Detailed configuration and operation of the image processor 110 will be described later with reference to FIG. 4.

The broadcast receiver 140 receives a broadcast signal from a broadcasting station or a satellite by wire or wireless and demodulates the broadcast signal. In detail, the broadcast receiver 140 may output a digital transmission stream signal by receiving and demodulating a transmission stream through an antenna or a cable.

The signal divider 145 divides the transmission stream signal provided from the broadcast receiver 140 into an image signal, an audio signal, and an additional information signal. The signal divider 145 also transmits the image signal and the audio signal to the A/V processor 150.

The A/V processor 150 performs signal processing, such as video decoding, video scaling, audio decoding, or the like, with respect to the image signal and the audio signal input from the broadcast receiver 140 and the storage unit 165. Video decoding and video scaling have been described as being performed by the A/V processor 150 in the present exemplary embodiment, but the above-described operation may be performed by the image processor 110. Also, the A/V processor 150 outputs the image signal to the image processor 110 and the audio signal to the audio output unit 155.

If the received image and audio signals are stored in the storage unit 165, the A/V processor 150 may output an image and an audio as compressed formats to the storage unit 165.

The audio output unit 155 converts the audio signal output from the A/V processor 150 into a sound and outputs the sound through a speaker or outputs the sound to an external device connected through an external output terminal.

The storage unit 165 may store an image content. In detail, the storage unit 165 may receive an image content, into which the image and the audio are compressed, from the A/V processor 150 and store the image content and may output the stored image content to the A/V processor 150 under control of the processor 120.

The storage unit 165 may also store a pre-captured or pre-generated background image. Also, the storage unit 165 may store a program or a content corresponding to various types of objects that may be displayed when operating in the second operation mode. In addition, the storage unit 165 may store a plurality of lookup tables used for viewing angle improvement processing. The storage unit 165 may be realized as a hard disk, a nonvolatile memory, a volatile memory, or the like.

The manipulator 175 may provide a user manipulation of the display apparatus 100 by being realized as a touch screen, a touch pad, a key button, a keypad, or the like. In the present exemplary embodiment, an example of inputting a control command through the manipulator 175 of the display apparatus 100 has been described. However, the manipulator 175 may receive a user manipulation from an external control device (e.g., a remote controller).

The communicator 170 is an element that performs communications with various types of external devices according to various types of communication methods. The communicator 170 may include a WiFi (Wireless-Fidelity) chip and a Bluetooth chip. The processor 120 may perform communications with various types of external devices by using the communicator 170. In detail, the communicator 170 may receive a control command from a control terminal apparatus (e.g., a remote controller) capable of controlling the display apparatus 100.

The communicator 170 may acquire weather information through a communication with an external server.

According to exemplary embodiments, the communicator 170 may further include various types of external input ports for connecting the display apparatus 100 to various types of external terminals such as a Universal Serial Bus (USB) port through which a USB connector may be connected, a headset, a mouse, Local Area Network (LAN), and the like, a Digital Multimedia Broadcasting (DMB) chip that receives and processes a DMB signal, and the like.

The sensor unit 180 senses a light environment of a periphery of the display apparatus 100. In detail, the sensor unit 180 may sense a light direction by using a plurality of sensors that are disposed in positions separated from one another on the display apparatus 100. Here, the sensor unit 180 may be an illuminance sensor that senses a luminance or a color sensor that senses a luminance, a color temperature, and the like. The above-described sensor may have a form that is embedded in a frame of the display apparatus 100 not to be affected by light emitted from the display 200.

Therefore, if the sensor unit 180 includes two sensors, the sensor unit 180 may include one illuminance sensor and one color sensor or may include two color sensors. Both of the two sensors may be realized as illuminance sensors, but at least one color sensor may be included.

The sensor unit 180 may further include an Infrared (IR) sensor, an ultrasonic sensor, a radio frequency (RF) sensor, and the like and may sense a position of the user. The sensor unit 180 may capture a preset area by using an image pickup device such as a Complementary Metal Oxide Semiconductor (CMOS) or a Charge Coupled Device (CCD) and may sense the position of the user through an image analysis of a captured image.

The processor 120 controls an overall operation of the display apparatus 100. In detail, the processor 120 may control the image processor 110 and the display 200 to display an image according to a control command input through the manipulator 175 in the first operation mode.

If a change command of at least one of a size and a position of the main image is input through the manipulator 175, the processor 120 may control the display 200 to vary and display at least one of the position and the size of the displayed main image based on the input change command. Here, the change command may include a ratio change.

The processor 120 may include a Read Only Memory (ROM) 131, a Random Access Memory (RAM) 132, a Graphic Processing Unit (GPU) 133, a Central Processing Unit (CPU) 134, and a bus. The ROM 131, the RAM 132, the GPU 133, the CPU 134, and the like may be connected to one another through the bus.

The CPU 134 performs booting by using an Operating System (O/S) stored in the storage unit 165 by accessing the storage unit 165. The CPU 134 may also perform various types of operations by using various types of programs, contents, data, and the like stored in the storage unit 165. This operation of the CPU 134 is the same as the operation of the processor 120 of FIG. 2, and thus a repeated description thereof is omitted.

The ROM 131 stores a command set and the like for booting a system. If power is supplied by inputting a turn-on command, the CPU 134 boots the system by copying the O/S stored in the storage unit 165 into the RAM 132 and executing the O/S according to a command stored in the ROM 131. If the system is completely booted, the CPU 134 performs various types of operations by copying various types of programs stored in the storage unit 165 into the RAM 132 and executing the programs copied into the RAM 132.

If the display apparatus 100 is completely booted, the GPU 133 may generate a screen including various types of objects such as an icon, an image, a text, and the like. In detail, if the display apparatus 100 operates in the second operation mode, the GPU 133 may generate a screen including a preset object in a background image. The GPU 133 may also generate a screen including a shadow object corresponding to a displayed object and/or a shadow object corresponding to the frame of the display apparatus 100.

The GPU 133 may be constituted as an additional element such as the image signal generator or may be realized as an element such as a System On Chip (SoC) combined with the CPU 134 of the processor 120.

As described above, the display apparatus 100 according to the present exemplary embodiment may give a more immersion to a main image by displaying a background screen in an empty area appearing when displaying the main image.

FIG. 4 is a block diagram of a detailed configuration of the image processor 110 of FIG. 3.

Referring to FIG. 4, the image processor 110 may include a processor 111, a mixer 117, and an image quality post-processor 118.

The processor 111 performs image processing with respect to a plurality of video signals. In detail, the processor 111 may simultaneously perform image processing with respect to a plurality of layers. The processor 111 may include a decoder 112, a scaler 113, an image quality processor 114, a window 115, and a graphic buffer 116.

The processor 111 determines whether an attribute of an input image is a video signal or a graphic signal, and if the attribute of the input image is the video signal, processes the image by using the decoder 112, the scaler 113, and the image quality processor 114. For example, an image of a video attribute is input into the processor 111 through an input unit 210, the decoder 112 decodes the input video image, the scaler 113 scales the decoded video image, and the image quality processor 114 performs image quality processing on the scaled video image and outputs the image-quality-processed video image to the mixer 117. Here, the image of the video attribute may be an image input from an external source or an image of a video content pre-stored in the display apparatus 100.

If the attribute of the input image is the graphic signal, the processor 111 processes the image by using the window 115 and the graphic buffer 116. For example, if an object image of a graphic attribute (e.g., a game image, a background image, or an object) is input through the input unit 210, the processor 111 may render the graphic signal to the graphic buffer 116 through the window 115 and may output an image generated in the graphic buffer 116 to the mixer 117.

The processor 111 as described above may process a plurality of images and may also process a plurality of layers. The processor 111 has been described as processing two signals including one video signal and one graphic signal, but the present exemplary embodiment is not limited thereto. The processor 111 may process each of two video signals by using a plurality of layers or may process each of two graphic signals by using a plurality of layers. The processor 111 may also process each of the two video signals or the two graphic signals by using three or more layers not two layers.

The image quality processor 114 may perform image processing for various types of image quality improvements with respect to an image according to a video signal and a graphic signal. Here, image processing may be viewing angle improvement processing, white balance controlling, noise removing, or the like.

The mixer 117 may mix two images transmitted from the processor 111 as one image. In detail, the mixer 117 may output a mixed image including a main image and a background image by mixing a second layer corresponding to the background image with merely an empty area of a first layer corresponding to the main image.

Also, the image quality post-processor 118 may perform image quality processing (e.g., White Balance (W/B)) on the mixed image and transmit the image-quality-processed image to the display 200.

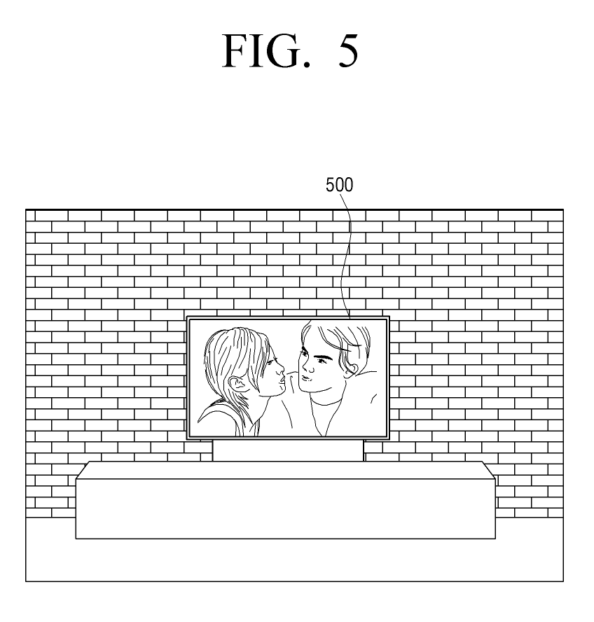

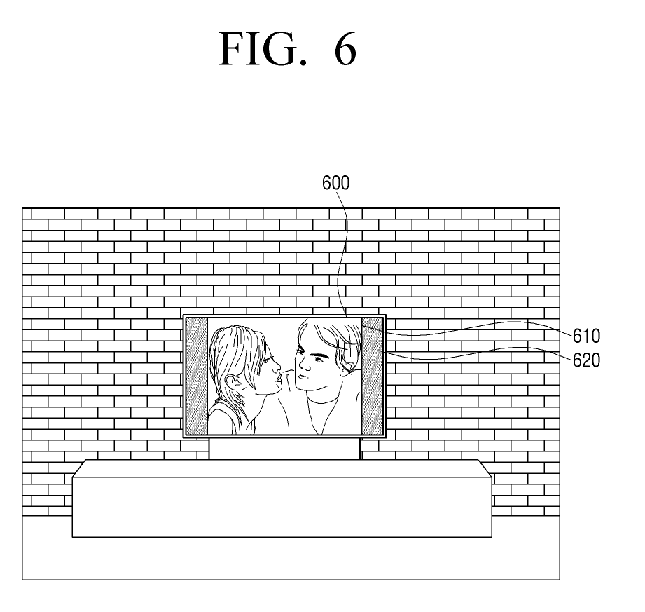

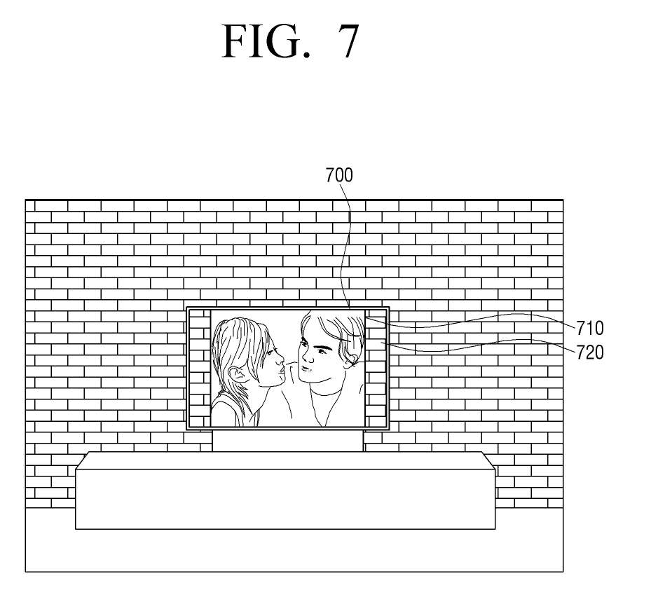

FIG. 5 illustrates an example of a display displayed when operating in the first operation mode. FIGS. 6 and 7 illustrate various examples of a display screen according to changes in a screen ratio.

Referring to FIG. 5, a display screen 500 operates in the first operation mode and displays a content at a preset ratio (e.g., 16:9).

If the user changes a display ratio of the content in this state, for example, to 4:3, a display screen 600 may display a content 610 at a changed ratio as shown in FIG. 6, according to a comparative example. As the content 610 is displayed at the changed ratio as described above, an area where an image of the content 610 is not positioned appears as an empty area 620 (or a black area) according to a ratio difference.

If the user sees a screen as described above, a background, an empty area, and a content screen are displayed in front of the user, and thus an immersion in the content screen is lowered.

In an exemplary embodiment, a background screen is displayed in an empty area in order to prevent an obstruction of a user immersion caused by the empty area. As a result, as shown in FIG. 7, a display screen 700 displays a main image 710 and a background image 720 together. Therefore, the user may concentrate better on the main image 710.

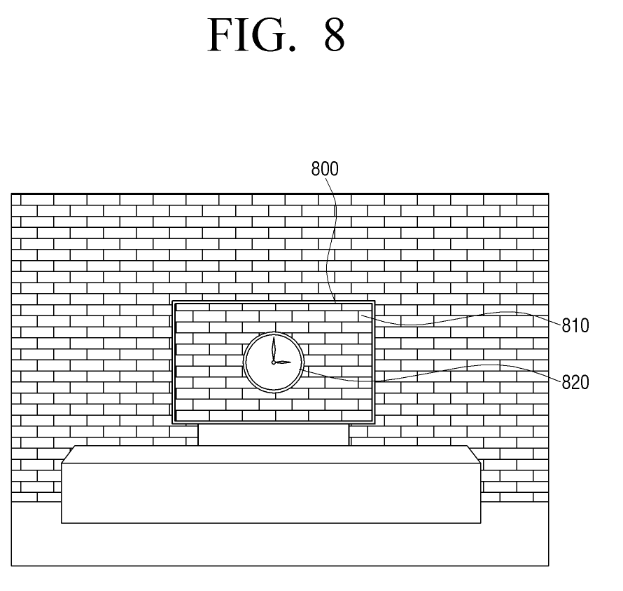

FIG. 8 illustrates an example of a display screen displayed when operating in the second operation mode.

Referring to FIG. 8, a display screen 800 operates in the second operation mode and displays an image of an actual background located behind the display screen 800 as a background screen 810.

Also, the display screen 800 displays a clock object 820 together with the background screen 810. For example, the clock object 820 is laid over the background screen 810. A user who sees such a screen feels as if a clock is positioned on a wall.

In the exemplary embodiment, an analog clock is illustrated as a graphic object laid over the background screen 801, but this is a mere example, and various types of objects such as a digital clock, a photo, a moving graphic image (e.g., a fishbowl image), and the like may be applied.

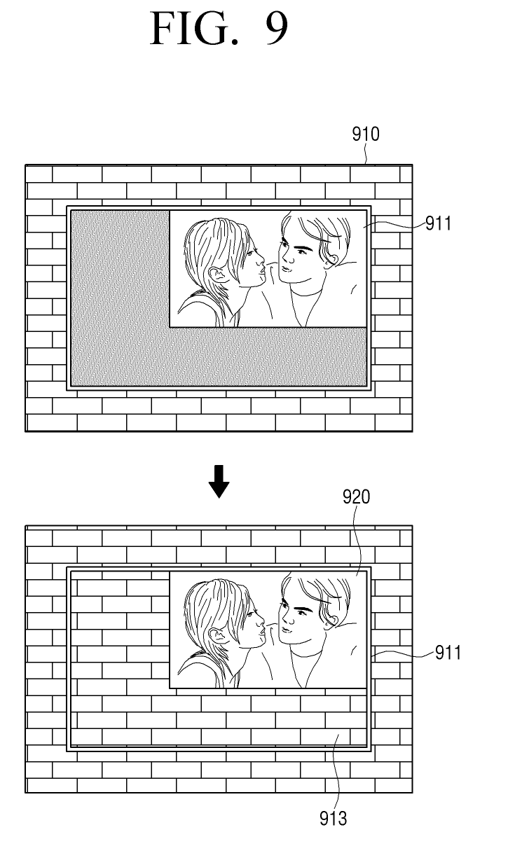

FIG. 9 illustrates an example of a display screen displayed according to a position change of a main screen.

Referring to FIG. 9, the user may control a position or a size of a main image by using a manipulator. For example, the display apparatus 100 may adjust a size and a position of a main screen 911 according to a user input. Also, the display apparatus 100 may adjust a size and a position of an empty area according to a user input.

Therefore, in the present exemplary embodiment, a background screen may be displayed in an empty area 913 where the main image 911 is not displayed when displaying the main image 911 having a size changed according to a user manipulation.

A related-art display apparatus may not freely control a size of a screen or may not change a position of the screen for aesthetic reasons caused by the empty area. However, the display apparatus 100 according to the present exemplary embodiment may replace an empty area with a background screen and thus may further freely control a size and a position of a main screen.

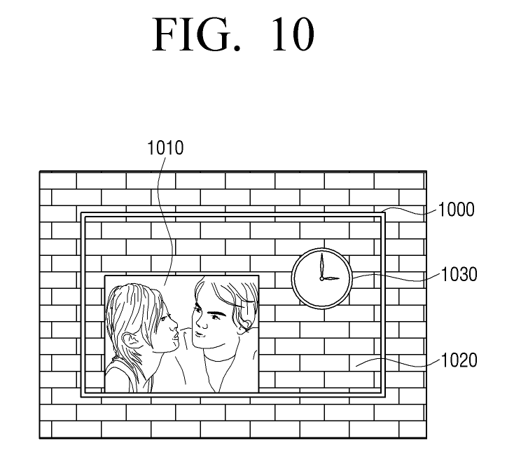

Also, as a freedom degree of the control of the size of the main screen as described above increases, the display apparatus 100 may variously use an empty area. For example, an object such as a clock may be displayed together in an area where a main image is not displayed. This will now be described with reference to FIG. 10.

FIG. 10 illustrates an example of a display screen on which a third image is displayed together.

Referring to FIG. 10, a display screen 1000 displays a main image 1010, a background image 1020, and a third image 1030 together.

Here, the third image 1030 may be a clock object as in the illustrated example but is not limited thereto.

For example, the third image 1030 may be another moving image (e.g., a sub image). A related art display apparatus may display two images (e.g., a main image and a sub image) using a Picture In Picture (PIP) function. However, the PIP function has a problem in that a user may not see a portion of a main image as a sub image is displayed in an area of the main image. However, in a method according to the present exemplary embodiment, a main image and a third image may be displayed in different areas.

The third image may be an image transmitted from an external apparatus. For example, the third image may be an image captured through an intercom at a front door. Therefore, the display apparatus 100 according to the present exemplary embodiment may converge an existing intercom (or videophone) function.

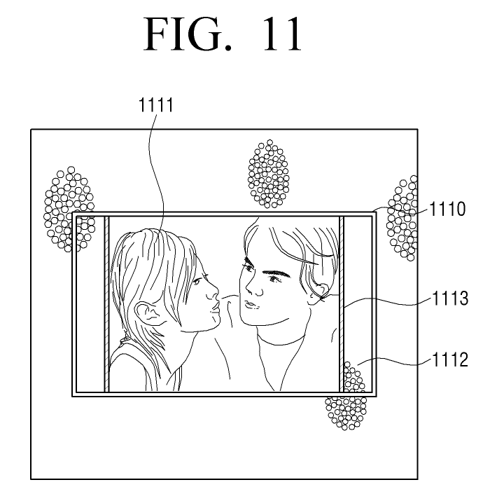

FIG. 11 illustrates an example of a display screen further displaying a virtual bezel.

Referring to FIG. 11, a display screen 1110 further displays a virtual bezel 1113 between a main image 1111 and a background image 1112 when displaying the main image 1111 and the background image 1112. Also, in order to further increase reality of the virtual bezel 1113, the display screen 1110 may display a shadow object of the virtual bezel 1113 together.

By displaying a virtual bezel as described above, the user may feel as if only the area displaying a main image is the entire area of a display apparatus.

Also, a main image has been illustrated and described as being displayed in a fixed position in the illustrated example. However, the main image and a virtual bezel may move with time. As a result, an effect of enabling a display apparatus to float and move over a wall may be provided.

FIG. 12 illustrates an example of checking a preset pattern and controlling a background screen according to the checked preset pattern.

Referring to FIG. 12, a display screen 1210 includes a main screen 1211 and a background screen 1212.

However, if the background screen 1212 includes a particular pattern, and the particular pattern of the background screen 1212 is disposed to be immediately adjacent to the main screen 1211, the user may be hindered in an immersion in the main screen 1211 by the particular pattern.

If the immersion in the main screen 1211 is hindered by the particular pattern of the background screen 1212 as described above, the display apparatus 100 may prevent the immersion in the main screen 1211 from being hindered by moving a pattern 1213 on the background screen 1212.

FIG. 13 illustrates an example of displaying a background screen in an empty screen if a display apparatus pivots.

Referring to FIG. 13, the display apparatus 100 operates in a transverse mode 1310.

If the user rotates the display apparatus 100 90 degrees clockwise, the display apparatus 100 may operate in a longitudinal mode 1320.

Therefore, the display apparatus 100 controls and displays a size and a position of a main image according to a changed mode. Since an empty area appears according to this control, the display apparatus 100 displays a background screen 1323 in the empty area where a main image 1321 is not displayed. Since an area hidden behind the display apparatus 100 changes according to whether the display apparatus 100 is in the transverse mode 1310 or the longitudinal mode 1320, the display apparatus 100 may display a different background screen according to whether the display apparatus 100 is in the transverse mode 1310 or the longitudinal mode 1320.

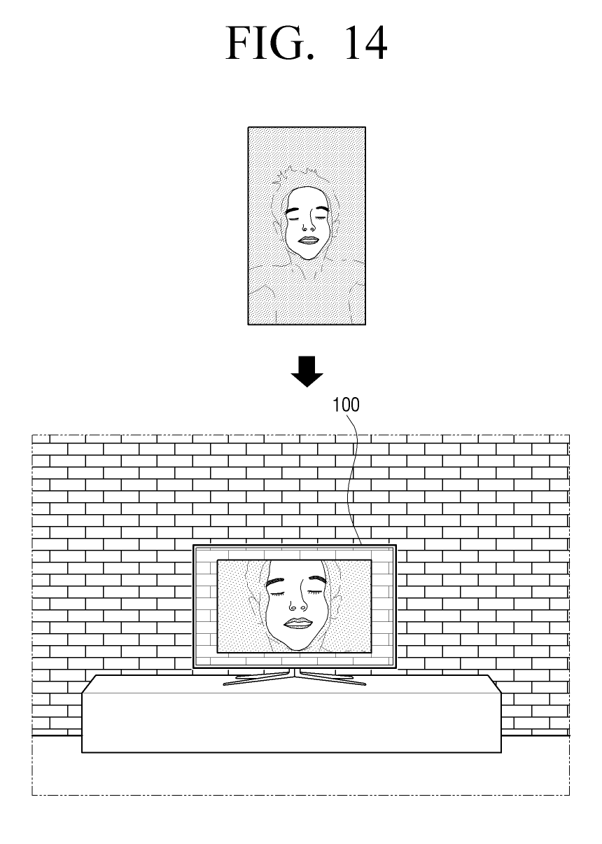

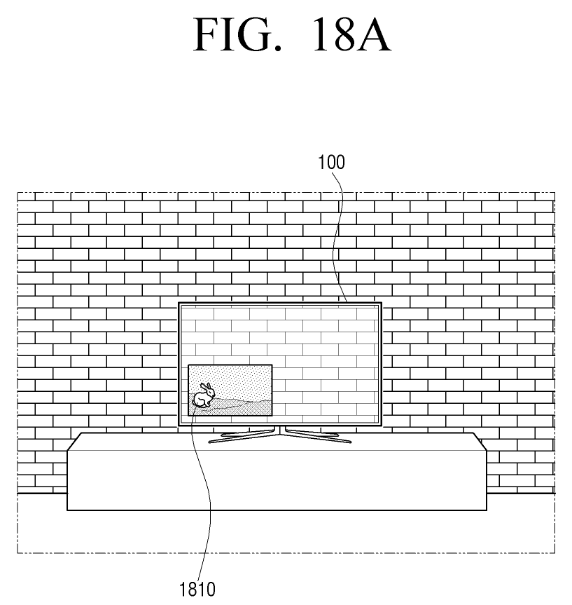

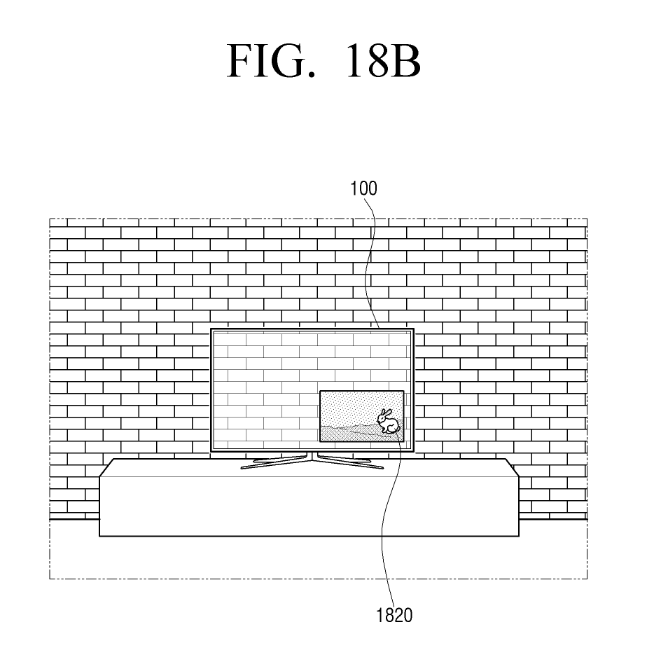

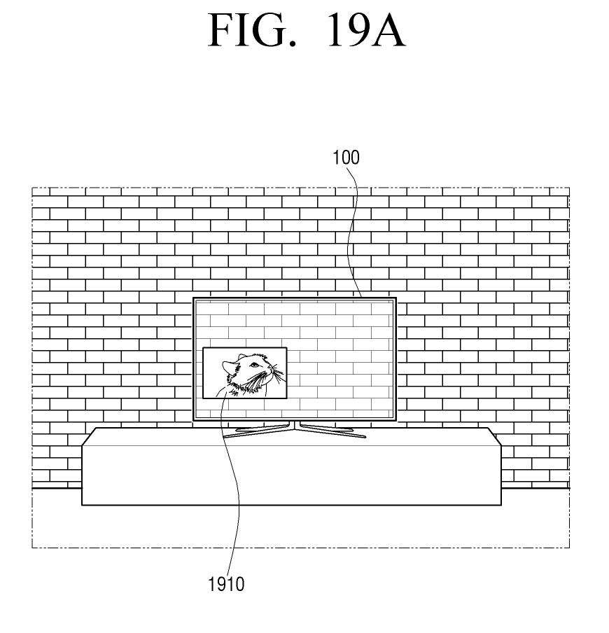

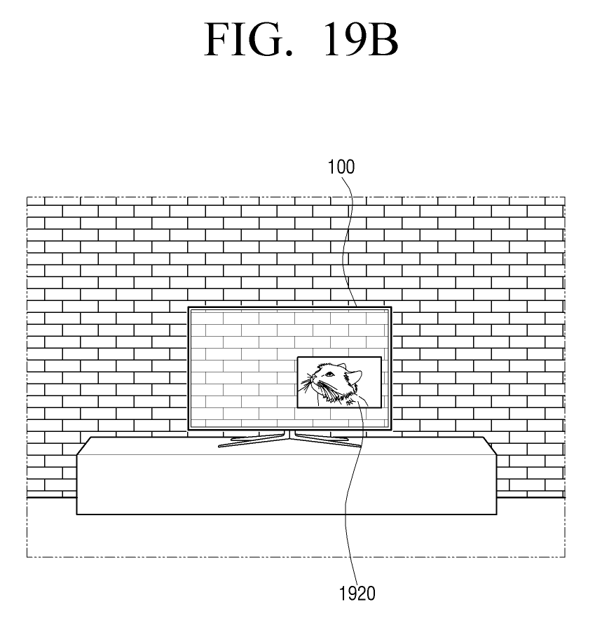

FIGS. 14 through 17 illustrate an example of extracting an object included in a main image and displaying an image including the extracted object in an area of a display by using a display apparatus. In FIGS. 14 through 17, for convenience of description, an object extracted from a main image is illustrated in a center of a display but is not necessarily limited thereto. According to a method that will be described later with reference to FIGS. 18 and 19, an object extracted from a main image may be disposed in one of upper, lower, left, and right areas of a central area of a display.

FIG. 14 illustrates a method of extracting an object and displaying the extracted object in an area of a display if a main image includes a foreground image and a background image in a display apparatus, according to an exemplary embodiment.

If a main image includes a foreground image and a background image, the processor 120 may extract the foreground image as an object and control the display 200 to display the extracted foreground image in an area of a display.

Here, the foreground image is a subject existing closest to a camera in an image captured by the camera, i.e., an image distinguished from the background image existing in a long distance. For example, if a person who is seeing the sky is captured from above the person, the processor 120 may recognize a face of the person as a foreground image and recognize a land image behind the face of the person, a body image of the person, and the like as a background image.

In detail, referring to FIG. 14, if the person is captured from above when obliquely lying toward the sky in water, the processor 120 may recognize the face of the person as a foreground image and recognize an image of the water and the body of the person as a background image.

Therefore, the processor 120 may extract a person's face portion as an object from a main image and display the person's face portion in an area of a display.

For this, the display apparatus 100 according to an exemplary embodiment may further include a face recognition module. As a result, the processor 120 may extract an object including a person's face recognized through the face recognition module and display the extracted object in the display.

Here, a person's face has been described as an example, but this is merely an exemplary embodiment. A main image may be an image including an animal's face or various types of images where a foreground image such as a food image, a flower image, or the like is constituted together with a background image. Also, the display apparatus 100 according to an exemplary embodiment may further include an object recognition module for recognizing food, a flower, or the like.

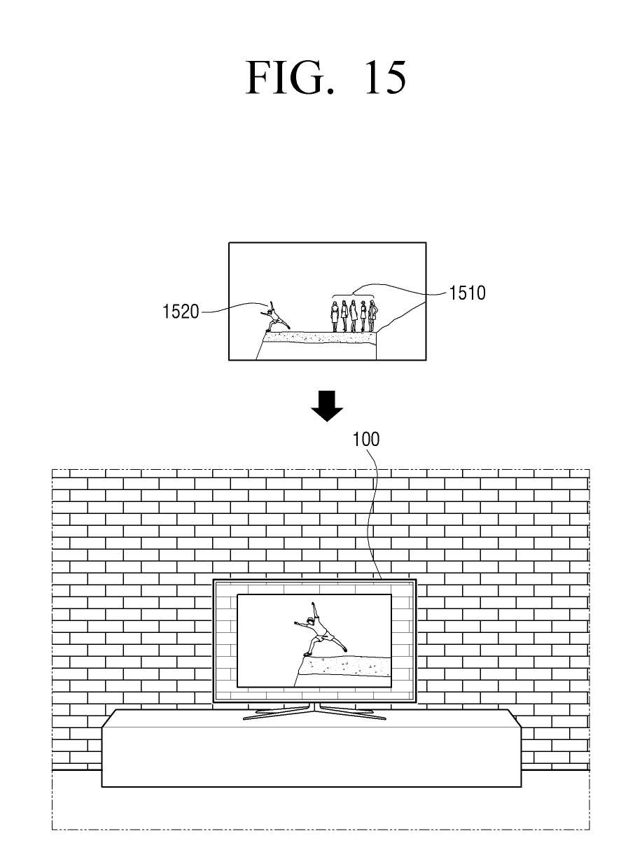

FIG. 15 illustrates a method of extracting other objects except for objects arranged in the same pattern among a plurality of objects and displaying the extracted objects in an area of a display if some of the plurality of objects included in a main image are arranged in the same pattern in a display apparatus, according to an exemplary embodiment.

If a plurality of objects are included in a main image, and some of the plurality of objects are arranged in the same pattern, the processor 120 may extract other objects except for the some of the plurality of objects and display the extracted objects in an area of the display.

Here, the processor 120 may use Hough transformation in order to determine a pattern of an object included in the main image. In detail, the processor 120 may extract line segments included in the main image by using the Hough transformation and determine a pattern of an object based on an arrangement state of the line segments.

For example, as shown in FIG. 15, if a plurality of human figures 1510 and 1520 are included in a main image, some human figures 1520 of the plurality of human figures 1510 and 1520 are arranged in the same pattern, i.e., arranged in a line, the processor 120 may recognize the human figures 1520 arranged in the line as the same pattern.

The processor 120 may also extract an object having other human figures distinguished from the human figures arranged in the line. Here, the object having the other human figures except for the human figures arranged in the line may be the human figure 1510 arranged in an oblique form.

Therefore, the processor 120 may extract the human figure 1510 arranged in the oblique form from the main image and display the extracted human figure 1510 in an area of the display.

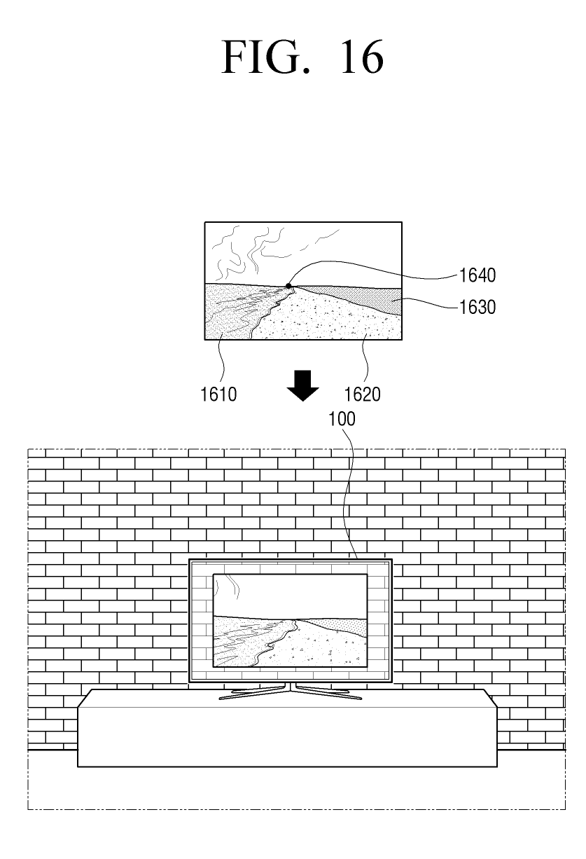

FIG. 16 illustrates a method of extracting an area from a main image based on a vanishing point and displaying the extracted image in an area of a display in a display apparatus according to an exemplary embodiment.

The processor 120 may determine a vanishing point from a background image included in the main image, extract an area based on the vanishing point, and display the extracted area in an area of the display. Here, the vanishing point may refer to a point where extension lines meet when the extension lines are drawn to extend from line segments included in the main image.

The processor 120 may determine a vanishing point from an image included in the main image by using Hough transformation. In detail, the processor 120 may extract line segments included in the main image by using the Hough transformation and determine a point, where extension lines of the extracted line segments meet, as a vanishing point.

For example, as shown in FIG. 16, if a sea 1610, a sandy beach 1620, and an asphalt road 1630 are included in a main image, the processor 120 may determine a vanishing point 1640, where extension lines meet, by extracting line segments included in the main image by using Hough transformation and extending the extracted line segments.

Therefore, the processor 120 may extract an area from a main image based on a vanishing point and display the extracted area in an area of a display.

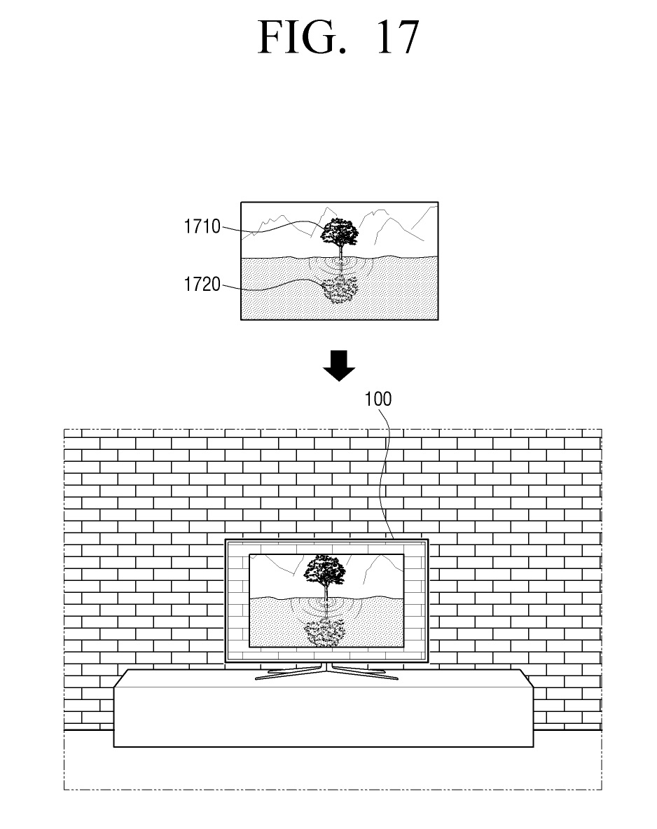

FIG. 17 illustrates a method of extracting an area based on objects symmetrical to each other and displaying an extracted image in an area of a display if the symmetrical objects exist in a main image in a display apparatus according to an exemplary embodiment.

If a first object and a second object symmetrical to the first object exist in a main image, the processor 120 may extract the first and second objects and display the extracted first and second objects in an area of a display.

In particular, the processor 120 may extract line segments from an image included in the main image by using Hough transformation and determine symmetrical objects based on the extracted line segments.

For example, referring to FIG. 17, the processor 120 may extract line segments of a first object 1710 and a second object 1720 included in a main image by using Hough transformation and determine whether the line segments included in the first object 1710 and the second object 1720 are symmetrical to each other.

Also, if it is determined that the first object 1710 and the second object 1720 are symmetrical to each other, the processor 120 may extract an area of the main image based on the first object 1710 and the second object 1720 and display the extracted area on the display. In the extracted area of the main image, the first and the second objects 1710 and 1720 may appear at the center. Additionally, the entire portions of the first and the second objects 1710 and 1720 may be displayed in the extracted area without being cut out.

As described above, a pattern of an object is analyzed, a vanishing point is extracted, and symmetrical objects are determined by using Hough transformation, but the present exemplary embodiment is not necessarily limited thereto. The processor 120 may analyze a pattern of an object, extract a vanishing point, and determine symmetrical objects according to various methods.

As described above with reference to FIGS. 14 through 17, the display apparatus 100 according to an exemplary embodiment may extract and display a particular area from a main image. Here, an extracted image may an area extracted based on an object included in the main image, i.e., may be a portion which is a point of the main image. Therefore, the present exemplary embodiment may provide the user with an area which is a point of a main image and an interested area of the main image.

FIGS. 18A and 18B illustrate a method of displaying a main image in an area of a display based on an attribute of an object included in the main image.

FIGS. 18A and 18B illustrate that a position of a main image displayed on a display is changed according to a position of an object existing in the main image.

The processor 120 may determine a position of an object from a main image. The display apparatus 100 according to an exemplary embodiment may further include an object recognition module or a figure recognition module.

In detail, the processor 120 may recognize an object and determine in which area the object exists among an entire area of the main image through the object recognition module or the figure recognition module.

The processor 120 may also determine a position where the main image will be displayed on a display according to a position of the determined object and display the main image in the determined position.

For example, as shown in FIG. 18A, if it is determined that an object 1810 exists in a left lower area of the main image, the processor 120 may determine an area corresponding to a position checked on the display, i.e., the left lower area of the display, as the position where the main image will be displayed and display the main image in the determined position.

Also, as shown in FIG. 18B, if it is determined that an object 1820 exists in a right lower area of the main image, the processor 120 may determine an area corresponding to a position checked on the display, i.e., the right lower area of the display, as a position where the main image will be displayed and display the main image in the determined position.

FIGS. 19A and 19B illustrate that a position of a main image displayed on a display is changed according to an eye direction of an object included in the main image.

The processor 120 may determine an eye direction of an object included in a main image. For this, the display apparatus 100 according to an exemplary embodiment may further include an eye direction recognition module. Here, the eye direction recognition module may detect an eye image included in the main image.

In detail, the eye direction recognition module may calculate difference values by respectively comparing the detected eye image with pre-stored eye images. The eye direction recognition module may also determine the eye image of the pre-stored eye images having the lowest difference value from the detected eye image and determine an eye direction of an object based on eye direction information mapped on the determined eye image.

Also, the processor 120 may determine a position of the main image displayed on the display based on the determined eye direction information of the object. In detail, the processor 120 may display the main image in an area of a display area opposite to an eye direction of the object.

For example, as shown in FIG. 19A, if an eye direction of an object 1910 is a right direction, the processor 120 may display the object 1910 in a left area of the display. Also, as shown in FIG. 19B, if an eye direction of an object 1920 is a left direction, the processor 120 may display the object 1920 in a right area of the display.

The main image shown in FIGS. 18A, 18B, 19A, and 19B may be an image of an area which is extracted from the main image according to the methods described with reference to FIGS. 14 through 17.

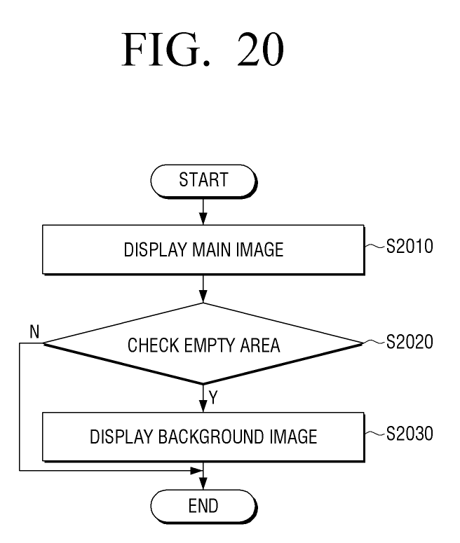

FIG. 20 is a flowchart of a display method according to an exemplary embodiment.

Referring to FIG. 20, a main image is displayed at a preset image ratio in operation S2010. In detail, the main image is displayed on a display according to an image ratio or a display method set by a user.

In operation S2020, it is determined whether an empty area where the main image is present on a screen of the display. For example, it is determined that the empty area exists when a black area exists on the display. Alternatively, a position where an image is displayed may be determined based on a pre-stored screen ratio of the display, a current screen ratio of a content, and the set display method, and an area where an image is not displayed, i.e., the empty area, may be checked through this.

If it is determined that the empty area exists, a background image is displayed in the empty area where the main image is not displayed in operation S2030. In detail, the background image may be displayed in the empty area where the main image is not displayed by generating a first layer corresponding to the main image, generating a second layer corresponding to the background image, and mixing the second layer with the empty area of the first layer.

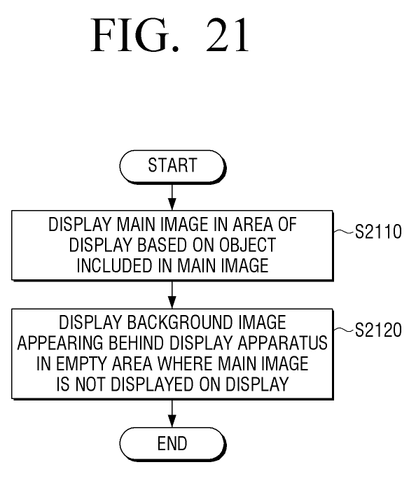

FIG. 21 is a flowchart of a display method according to another exemplary embodiment.

A display apparatus according to an exemplary embodiment may display a main image in an area of a display based on an object including the main image in operation S2110. In detail, the display apparatus may display the main image in the area of the display based on a position of the object existing in the main image and an eye direction of the object. Also, the display apparatus may also extract the object included in the main image and display the extracted object in an area of the display. Therefore, the display apparatus may provide a user with an object which is a point of the main image and enable the user to aesthetically enjoy an image by displaying the main image in a natural and stable position.

In operation S2120, the display apparatus may display an image of the background hidden behind the display apparatus in an empty area where the main image is not displayed on the display. Therefore, the display apparatus may give the user an immersion in viewing the main image.

While not restricted thereto, an exemplary embodiment can be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Also, an exemplary embodiment may be written as a computer program transmitted over a computer-readable transmission medium, such as a carrier wave, and received and implemented in general-use or special-purpose digital computers that execute the programs. Moreover, it is understood that in exemplary embodiments, one or more units of the above-described apparatuses and devices can include circuitry, a processor, a microprocessor, etc., and may execute a computer program stored in a computer-readable medium.

For example, methods according to various exemplary embodiments described above may be embodied as software or application forms that may be installed in an existing display apparatus.

Also, the methods according to the various exemplary embodiments described above may be embodied by upgrading software or hardware of the existing display apparatus.

In addition, the various exemplary embodiments described above may be performed through an embedded server of a display apparatus or an external server of the display apparatus.

There may be provided a non-transitory computer readable medium that stores a program sequentially performing a method of controlling a display apparatus according to the present invention.

In detail, the non-transitory computer readable medium may include displaying a main image in an area of a display based on an object included in the main image and displaying a background image appearing behind a display apparatus in an empty area where the main image is not displayed on the display.

The foregoing exemplary embodiments and advantages are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A display apparatus comprising:
a display configured to display a main image; and
a processor configured to control the display to display the main image at a preset image ratio that is different from an aspect ratio of the display, and in response to an empty area of the display where the main image is not displayed being present in the display, control the display to display a secondary image in the empty area,
wherein the secondary image corresponds to an image of a background area positioned behind the display apparatus or an image of a surrounding area that surrounds the display apparatus.

2. The display apparatus of claim 1, further comprising:
an image processor configured to generate a first layer corresponding to the main image, generate a second layer corresponding to the secondary image, and combine the first layer and the second layer to display the second layer in the empty area,
wherein the processor is further configured to control the display and the image processor to display the mixed image on the display.

3. The display apparatus of claim 2, wherein the image processor configured to mix the second layer with a black area of the first layer.

4. The display apparatus of claim 1, wherein the processor is further configured to control the display to display a virtual bezel on a boundary between the main image and the secondary image.

5. The display apparatus of claim 4, further comprising:
a sensor configured to sense an external light environment,
wherein the processor is further configured to determine a lighting direction based on the sensed external light environment and control the display to display a shadow object of the virtual bezel in a position corresponding to the determined lighting direction.

6. The display apparatus of claim 1, wherein in response to a portion of a pattern of the secondary image being displayed at a predetermined position in the empty area, the processor is further configured to control the display to change the position of the portion of the pattern within the empty area.

7. The display apparatus of claim 1, wherein the processor is further configured to control the display to display a third image in a preset area of the secondary image.

8. The display apparatus of claim 1, wherein the processor is further configured to extract an object included in the main image from the main image and control the display to display the extracted object in an area of the display.

9. The display apparatus of claim 8, wherein the main image comprises a foreground image and a background image, and the processor is further configured to extract the foreground image as the object from the main image and control the display to display the extracted object on the display.

10. The display apparatus of claim 8, wherein in response to a plurality of objects included in the main image being arranged uniformly, the processor is further configured to extract another plurality of objects except for the plurality of objects and control the display to display the extracted another plurality of objects on the display.

11. The display apparatus of claim 8, wherein the processor is further configured to determine a vanishing point from the background image of the main image, extract an area based on the vanishing point, and controls the display to display the extracted area on the display.

12. The display apparatus of claim 8, wherein in response to the main image comprising a first object and a second object symmetrical to the first object, the processor is further configured to extract the first and second objects from the main image and control the display to display the extracted first and second objects on the display.

13. The display apparatus of claim 8, wherein the processor is further configured to determine a position of the object included in the main image and control the display to display the main image in an area of the display corresponding to the determined position.

14. The display apparatus of claim 8, wherein the processor is further configured to determine an eye direction of the object included in the main image and control the display to display the main image in an area existing in an opposite direction to the determined eye direction on the display.

15. A display method comprising:
displaying, on a display, a main image at a preset image ratio;
determining whether an empty area where the main image is not displayed exists on the display; and
in response to determining that the empty area exists, displaying a secondary image in the empty,
wherein the secondary image corresponds to an image of a background area positioned behind the display or an image of a surrounding area that surrounds the display.

16. The display method of claim 15, wherein the displaying the secondary image comprises:
generating a first layer corresponding to the main image;
generating a second layer corresponding to the secondary image; and
combining the first layer and the second layer to display the second layer in the empty area.

17. The display method of claim 16, wherein the combining comprises combining the second layer with a black area of the first layer.

18. The display method of claim 15, wherein the displaying the secondary image comprises displaying a virtual bezel on a boundary between the main image and the secondary image.

19. The display method of claim 15, further comprising:
sensing an external light environment of the display; and
determining a lighting direction based on the sensed external light environment,
wherein the displaying the secondary image comprises displaying a shadow object of the virtual bezel together in a position corresponding to the determined lighting direction.

20. The display method of claim 15, wherein the displaying the secondary image comprises, in response to a portion of a pattern of the secondary image being displayed at a predetermined position in the empty area, changing the position of the portion of the pattern.
